(19) United States
(12) Patent Application Publication
(10) Pub. No.: US 2023/0084870 A1
(43) Pub. Date: Mar. 16, 2023

(54) Smart Mirror-Displayed Video Camera

(71) Applicant: Aaron Johnson, Portsmouth, VA (US)

(72) Inventor: Aaron Johnson, Portsmouth, VA (US)

(21) Appl. No.: 17/474,531

(22) Filed: Sep. 14, 2021

(51) Int. Cl. H04N 5/247; H04N 5/225; H04N 5/232; A47G 1/02

(52) U.S. Cl. CPC H04N 5/247; H04N 5/2256; H04N 5/23203; H04N 5/2257; A47G 1/02; G06F 3/02

(57) ABSTRACT

The camera-mirror device allows the user to view themselves on a big screen without needing to use electricity to power said screen. The mirror also has a couple visual effects for the subject of the photograph, using the lights to simulate camera flashes or create spooky bottom lighting. The mirror video camera or (just camera) can be paired with an electric device via Bluetooth to share photographs and videos taken BY given remote control over the settings. The body of the mirror and wooden frame are held by a bipedal stand in the back, which by a ball joint connection allows the mirror to be rotated and locked into place.

### BACKGROUND

A mirror or reflector is an object such that each narrow beam of light that falls on its surface is reflected in a single direction. This property, called specular reflection, distinguishes a mirror from objects that scatter light in many directions (such as flat-white paint), let it pass through them (such as a lens or prism), or absorb it. A mirror is commonly used for inspecting oneself, such as during personal grooming; hence the old-fashioned name looking glass. There have been no products available as original equipment or as an aftermarket to address this problem.

A selfie is a self-portrait digital photograph, typically taken with a digital camera or smartphone. Selfies are often shared on social media, via social networking services such as Facebook, Twitter, Snapchat, and Instagram. They are often casual in nature (or made to appear casual). “Selfie” typically refers to self-portrait photos taken with the camera held at arm's length, as opposed to those taken by using a self-timer or remote. A selfie, however, may include multiple subjects. As long as the photo is being taken by one of the subjects featured, it is considered a selfie. There have been no products available as original equipment or as an aftermarket to address this problem either.

There exists a need for a mirror-displayed camera device that is not being met by any known or disclosed device or system of present.

### SUMMARY OF THE INVENTION

The smart mirror-camera device allows the user to view themselves on a big screen without needing to use electricity to power said screen. The smart mirror also has a couple visual effects for the subject of the photograph, using lights to simulate camera flashes or create spooky bottom lighting. The smart mirror camera including audio and visual and other capabilities can pair with an electronic device via Bluetooth to share photographs taken and give remote control over the settings. The body of the mirror and wooden frame are held by a bipedal stand in the back, which by a ball joint connection allows the mirror to be rotated and locked into place.

A smart mirror disclosed includes a mirror having a backside and a forward side and disposed adjacent a screen as a reflective layer for the mirror. The disclosure also includes motion sensors (MS) attached to the backside of the mirror looking forward and activated by a motion forward of the mirror. The disclosure additionally includes audio visual cameras (AV) attached to the backside of the mirror wherein each AV camera is activated by one of the MS. The disclosure further includes lights stationed on the backside of the mirror wherein each of the lights is activated by one of the MS.

### BRIEF DESCRIPTION OF THE DRAWINGS

FIG. 1 is a front view of the mirror in accordance with an embodiment of the present disclosure.

FIG. 2 is a back view of the mirror and stand in accordance with an embodiment of the present disclosure.

FIG. 3 is an exploded back view of the mirror and stand in accordance with an embodiment of the present disclosure.

FIG. 4 is a detailed view of a control panel for the mirror-displayed camera in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term [term] is used to refer to [describe, rest of sentence]. The term [term] refers to [describe, rest of sentence].

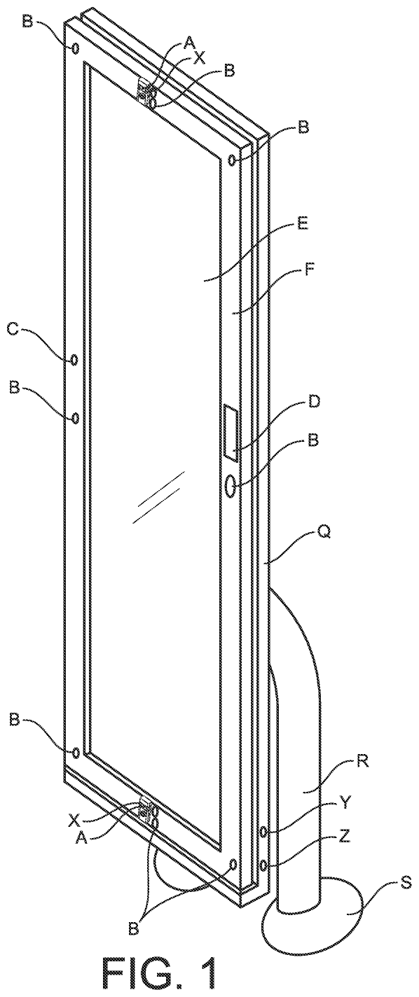

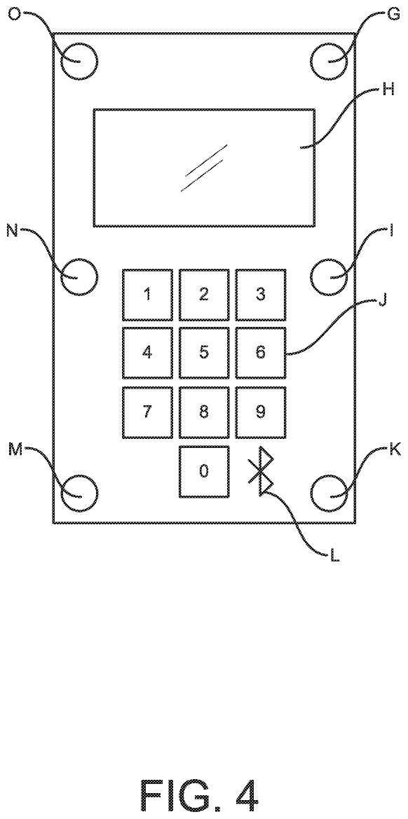

FIG. 1 is a front view of the mirror in accordance with an embodiment of the present disclosure. The full-length mirror face E is prominently depicted alongside the various button controls and elements on the wooden frame F. A video and audio camera A resides at the top and bottom of the frame. There are seven stationed lights B, one at each corner of the frame, two centered on the top and bottom of the frame respectively, and one vertically centered on the frame's left side. On the frame's right and left side are stationed speakers C. On the frame's left side is another video camera A below the manual control panel D detailed below in FIG. 4. The legs R, the feet S, and the LCD (liquid crystal display) Screen Q are partially visible and detailed in embodiments below. The illustration also includes the USB (universal serial bus) port Y and the 2 prong socket Z and X motion sensor as depicted. The LCD screen Q provides the reflective screen for the mirror and also provides a video display for playback and smart use of the mirror and recordings.

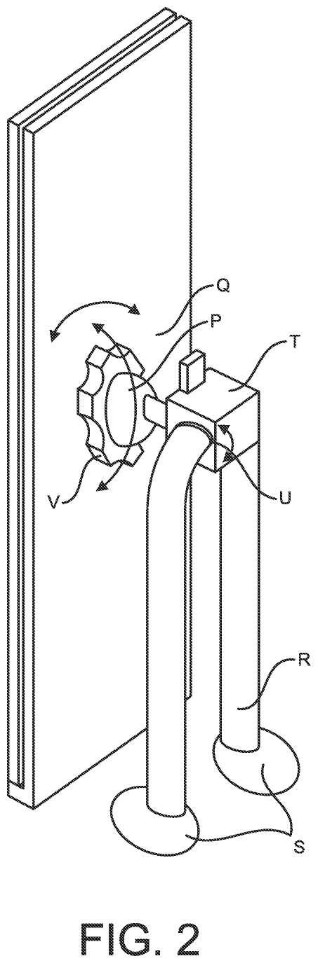

FIG. 2 is a back view of the mirror and stand in accordance with an embodiment of the present disclosure. On the back is depicted the back stand Q which supports the wooden frame F and mirror face E in the front. There is a rear ball joint P which can rotate and lock in relation to the back stand Q. The ball joint P is directly connected to a box T which is supported by two legs R and feet for stability S. Additionally, there is a pivoting mechanism U, which connects the box T to the legs R and can fold or bend with the locking nut V built adjacent to rear ball joint P.

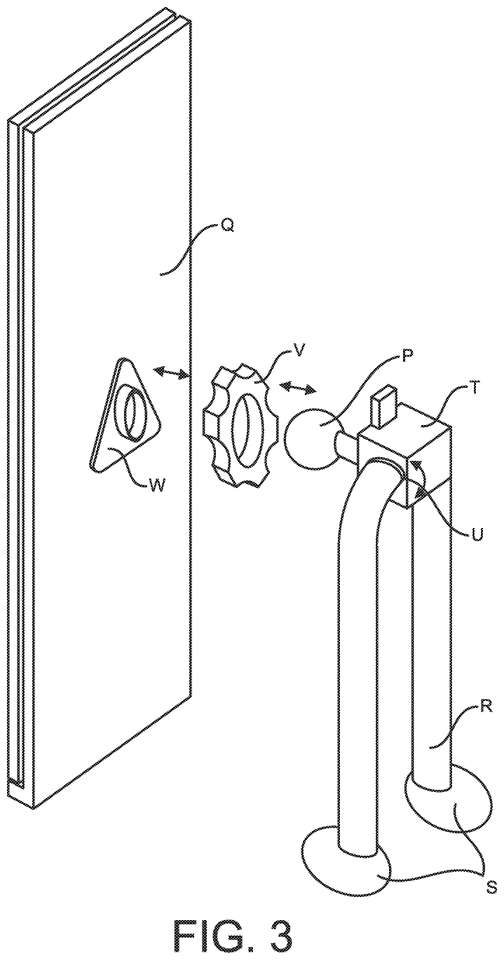

FIG. 3 is an exploded back view of the mirror and stand in accordance with an embodiment of the present disclosure. In addition to the reference letters and features of FIG. 2, this depiction includes the locking mechanism V disengaged from the locking plate W disposed on the back stand of the disclosure. Complementary threads are present on the locking nut V and the locking plate W so that a clockwise tightening of the locking nut V around the locking plate W secures the rear ball joint in place for mirror placement and use. A counter-clockwise loosening of the locking nut V around the locking plate W allows interchangeability of the mirror with the mirror stand for maintenance and replacement.

FIG. 4 is a detailed view of a control panel for the mirror-displayed camera in accordance with an embodiment of the present disclosure. On the front of the control panel is the keypad J and a small screen H. There is a Bluetooth component L on the bottom along with a clear button M, and WiFi button K on the bottom corners. On the top corners there is a settings button O and a power button G. On the left and right sides are two buttons: the enter button N and the menu button I, respectively.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A smart mirror comprising:
a mirror having a backside and a forward side and disposed adjacent a screen as a reflective layer for the mirror,
a plurality of motion sensors (MS) attached to the backside of the mirror looking forward and activated by a motion forward of the mirror,
a plurality of audio visual cameras (AV) attached to the backside of the mirror wherein each AV camera is activated by one of the plurality of MS; and
a plurality of lights stationed on the backside of the mirror wherein each of the plurality of lights is activated by one of the plurality of MS.

2. The smart mirror of claim 1, wherein the screen is an LCD (liquid crystal display) screen controlled by a manual control panel on the smart mirror.

3. The smart mirror of claim 1, wherein the plurality of AV cameras and the plurality of lights are control remotely by a wireless controller.

4. The smart mirror of claim 1, further comprising a plurality of audio speakers attached to the smart mirror and activated by one of the plurality of MS.

5. The smart mirror of claim 1, further comprising a support frame for the mirror and the screen and a bipedal stand supporting the support frame.

6. The smart mirror of claim 5, further comprising a ball joint configured to attach the bipedal stand to the support frame.

7. The smart mirror of claim 5, further comprising a locking nut and a locking plate configured to lock the mirror in relation to the support frame and the bipedal stand.

8. The smart mirror of claim 1, further comprising suction cup feet on each leg of the bipedal stand.

9. The smart mirror of claim 1, further comprising accessory ports for USB and other interfaces to the smart mirror.

10. The smart mirror of claim 1, wherein the mirror and the screen are full length relative to a user's height.

11. The smart mirror of claim 1, further comprising a remote control for the smart mirror comprising a plurality of separate buttons for clear screen, WiFi, settings, power, enter and menu.
